(19) United States
(12) Patent Application Publication
(10) Pub. No.: US 2018/0370112 A1
(43) Pub. Date: Dec. 27, 2018

(54) Method and Apparatus for Voltage Enhanced Thermoforming and Consolidation of Thermoplastic Carbon Reinforced Composites

(71) Applicant: Reliant Worldwide Plastics, LLC, Plano, TX (US)

(72) Inventor: William H. Maslakow, Lewisville, TX (US)

(21) Appl. No.: 15/900,422

(22) Filed: Feb. 20, 2018

Related U.S. Application Data
(60) Provisional application No. 62/461,071, filed on Feb. 20, 2017.

(51) Int. Cl. B29C 51/30; B29C 51/08; B29C 51/20; B29C 51/42; B29C 51/46; B29C 70/46

(52) U.S. Cl. CPC B29C 51/30; B29C 51/082; B29C 51/20; B29K 2101/12; B29C 51/46; B29C 70/46; B29C 51/428

(57) ABSTRACT

A thermoplastic processing system includes an upper form die and a lower form die. A plurality of electrical contact devices are disposed in at least one of the upper form die and the lower form die. The plurality of electrical contact devices make electrical contact with at least one carbon reinforcing layer upon insertion of the carbon reinforcing layer into at least one of the upper form die and the lower form die. The plurality of electrical contact devices are adapted to expose the at least one carbon reinforcing layer to an electrical current, thereby causing a temperature increase in the at least one carbon reinforcing layer. The plurality of electrical contact devices are adapted to monitor a resistance of the at least one carbon reinforcing layer during application of the electrical current.

### PRIORITY

This application claims the benefit of priority to U.S. Provisional Patent Application No. 62/461,071 filed Feb. 20, 2017, which is incorporated herein by reference.

### BACKGROUND

### Field of the Invention

The present invention relates to thermoforming and consolidation of thermoplastic components and more particularly, but not by way of limitation, to thermoforming and consolidation of thermoplastic carbon reinforced composites by utilizing the electrical resistance of the thermoplastic carbon reinforced composite to generate heat when an electrical current is selectively applied.

### History of the Related Art

Thermoplastic carbon reinforced composites are a matrix of carbon reinforcing fibers of a given strength and configuration encapsulated with a suitable thermoplastic material. The ratio of carbon reinforcing fibers to the thermoplastic material creates a high strength-to-weight ratio material suitable for numerous applications throughout many industries. This encapsulation process is commonly referred to as “consolidation.”

Thermoplastic carbon reinforced composite materials include at least one layer of ply of carbon reinforcing fibers woven in a specific pattern, encapsulated with suitable layers of thermoplastic resin to meet the load, performance, and weight requirements of the specific application.

A typical single layer or single ply thermoplastic carbon composite sheet or panel includes a thermoplastic material layer, a reinforcing carbon weave layer, and a thermoplastic material layering scheme. Multilayer or multiply systems include the layering scheme repeated by the number of layers or plys required for a specific application. The amount of thermoplastic resin for each layer is symmetric about the carbon reinforcement with thermoplastic residing on opposing sides of the carbon layer.

### SUMMARY

The present invention relates to thermoforming and consolidation of thermoplastic components and more particularly, but not by way of limitation, to thermoforming and consolidation of thermoplastic carbon reinforced composites by utilizing the electrical resistance of the thermoplastic carbon reinforced composite to generate heat when an electrical current is selectively applied. In one aspect, the present invention relates to a thermoplastic processing system. The thermoplastic processing system includes an upper form die and a lower form die. A plurality of electrical contact devices are disposed in at least one of the upper form die and the lower form die. The plurality of electrical contact devices make electrical contact with at least one carbon reinforcing layer upon insertion of the carbon reinforcing layer into at least one of the upper form die and the lower form die. The plurality of electrical contact devices are adapted to expose at least one carbon reinforcing layer to an electrical current, thereby causing a temperature increase in at least one carbon reinforcing layer. The plurality of electrical contact devices are adapted to monitor a resistance of at least one carbon reinforcing layer during application of the electrical current.

### BRIEF DESCRIPTION OF THE DRAWINGS

For a more complete understanding of the present invention and for further objects and advantages thereof, reference may now be had to the following description taken in conjunction with the accompanying drawings in which:

FIG. 1 is a flow diagram illustrating a voltage-enhanced consolidation and thermoforming process in accordance with an exemplary embodiment;

FIG. 2A is a perspective view of voltage-enhanced consolidation system in accordance with an exemplary embodiment;

FIG. 2B is a detail view of the voltage-enhanced consolidation system of FIG. 2A in accordance with an exemplary embodiment;

FIG. 2C is a flow diagram illustrating a voltage-enhanced consolidation process in accordance with an exemplary embodiment;

FIG. 2D is a detail view of the voltage-enhanced consolidation system of FIG. 2A illustrating a plurality of cooling channels in accordance with an exemplary embodiment;

FIG. 2E is a detail cut-away view of the voltage-enhanced consolidation system of FIG. 2A illustrating a plurality of electrical contact devices in accordance with an exemplary embodiment.

FIG. 3A is a perspective view of voltage-enhanced thermoforming system in accordance with an exemplary embodiment;

FIG. 3B is a detail view of the voltage-enhanced thermoforming system of FIG. 3A in accordance with an exemplary embodiment;

FIG. 3C is a flow diagram illustrating a voltage-enhanced thermoforming process in accordance with an exemplary embodiment;

FIG. 3D is a detail view of the voltage-enhanced consolidation system of FIG. 3A illustrating a plurality of cooling channels in accordance with an exemplary embodiment;

FIG. 4A is a perspective view of voltage-enhanced consolidation and thermoforming system in accordance with an exemplary embodiment;

FIG. 4B is a detail view of the voltage-enhanced consolidation and thermoforming system of FIG. 4A in accordance with an exemplary embodiment,

FIG. 4C is a flow diagram illustrating a voltage-enhanced consolidation and thermoforming process in accordance with an exemplary embodiment; and FIG. 4D is a perspective view of a voltage-enhanced consolidation and thermoforming system in one embodiment;

FIG. 5A is an exploded cut away enlarged view of a consolidation system with redundant resistance temperature detection (RTD) according to an exemplary embodiment;

FIG. 5B is an exploded cut away enlarged view of a thermoforming system with redundant resistance temperature detection (RTD) according to an exemplary embodiment; and

FIG. 5C is an exploded cut away enlarged view of a simultaneous consolidation and thermoforming system with redundant resistance temperature detection (RTD) according to an exemplary embodiment.

### DETAILED DESCRIPTION

Various embodiments of the present invention will now be described more fully with reference to the accompanying drawings. The invention may, however, be embodied in many different forms and should not be construed as limited to the embodiments set forth herein.

Multilayers of thermoplastic-carbon-thermoplastic form significant high strength-to-weight ratio components and assemblies. The aforementioned consolidation process is typically accomplished with a heating and pressure process supplied by an external heat source, forming die tooling and a high pressure clamping presses. The external heat source transfers thermal energy through the forming die tooling to the thermoplastic and softens the thermoplastic materials to a flowing state. The clamping pressure applied to the forming die tooling provides displacement forces to the thermoplastic resin which precipitates the flow of the thermoplastic resin into the reinforcing carbon material.

Upon removal of the heat source, the thermoplastic solidifies into a rigid state. The displaced thermoplastic encases or encapsulates the reinforcing carbon to create a rigid thermoplastic composite layer. A cooling process is typically included in the process cycle to support the solidification of the thermoplastic resin. Upon solidification, the clamping pressure is terminated and the finished part is removed from the forming die tooling.

Consolidation is typically utilized to produce flat sheet or panel thermoplastic carbon composites that can be subsequently formed into a desired geometry or fabricated into flat planar components such as aerospace bulkhead panels, for example.

In another process, forming or bending of the pre-consolidated thermoplastic carbon composite sheet or panel into a pre-defined 3 dimensional (3D) geometry maybe employed. This process is commonly referred to as Thermoforming.

Thermoforming utilizes forming die tooling configured into a pre-defined 3D geometry. The forming die tooling is typically a matched form die set with one side of the part geometry provided into one side of the form die, and the opposing part geometry provided into the opposing form die. A male-female geometric matched forming die set is provided with a defined space between the mating face surfaces that is representative of the thickness and geometry of the desired finished component.

The thermoforming process is accomplished by applying said heating and pressure process to the matched thermoforming die tooling. The heat source transfers thermal energy through the forming die tooling to the thermoplastic carbon composite sheet or panel and softens the thermoplastic carbon composite to a semi-flowing state. The clamping pressure applied to the forming die tooling provides displacement forces to the thermoplastic carbon composite which precipitates the forming or bending of thermoplastic carbon composite into the desired geometry.

Upon removal of the heat source, the now formed thermoplastic composite solidifies into a rigid state. A cooling process is typically included in the process cycle to support the solidification of the formed thermoplastic composite. Upon solidification, clamp pressures are terminated and the finished formed part is removed from the forming die tooling.

In even another similar process, simultaneous consolidation and thermoforming of specific 3D part geometries may be employed. This process is commonly referred as Consolidation Thermoforming.

This process is relatively the same as the aforementioned consolidation and thermoforming processes but performed simultaneously within the same forming die tooling. Layers of said thermoplastic-carbon-thermoplastic are placed into a consolidation-thermoforming die tool configured with the appropriate 3D part geometry. The aforementioned heat and pressure process is provided and a subsequent consolidation and thermoforming of the thermoplastic material and carbon reinforcement is achieved simultaneously. Solidification during the cooling cycle completes the process and the part is removed from the forming die tooling.

As mentioned in all the aforementioned processes, a specific heating process is required to soften the thermoplastic materials to a state which allows manipulation of the thermoplastic for the purpose of consolidation or thermoforming.

Common methods employed to apply the required heat or thermal energy to a level to support the softening or melting of the thermoplastic material include numerous electric cartridge heaters installed in the forming die tooling, to liquid media thermal energy transfer systems whereby the thermal energy within oil or other suitable liquid media is transferred to the tooling through connections and channels within the tooling. The said methods are commonly utilized for both consolidation and thermoforming processes.

Additionally, other alternative heating sources, such as infrared, focused infrared, ceramic or formed coil heaters for example, may be also be employed that introduce heat or thermal energy onto the thermoplastic composite sheet or panel externally. These types of heating or thermal energy sources are typically used only for thermoforming.

Said heat source is directed to the surfaces of the thermoplastic composite material that is suspended above or adjacent to the forming die tooling. Upon reaching the desired process temperature of the thermoplastic composite sheet or panel, the heat source is removed and the thermoplastic is then quickly moved to the forming die tooling and formed to the desired geometry. Supplementary heating within the forming die tooling may also be utilized to maintain tooling temperatures during the thermoforming process. Consolidation process temperatures may be achieved utilizing external heat sources however the handling of un-consolidated layers of thermoplastic-carbon-thermoplastic in an unsupported suspended manner is not practical or controllable.

Thermoplastic materials must be processed within a specific controlled temperature range. If the process temperature is to low, melt or flow integrity may be compromised due to the lack of thermal energy to promote manipulation, merging or encapsulation. If the process temperature is too high, degradation occurs and the thermoplastic material loses critical mechanical and environmental properties.

Lack of proper temperature control will adversely affect the merging or encapsulation of the thermoplastic material to the carbon material during consolidation or the manipulation of the thermoplastic carbon composite during thermoforming.

Of equal importance is a consistent cycle time for a given process. Consistent cycle times ensure repeatability which equates to consistent part quality, part performance, increased yields and reduced rejection rates during inspection. Inconsistent process temperatures equate to variations in processing or cycle times that adversely affect part quality, performance, reduce yields and increase rejection rates during inspection.

It becomes paramount that very precise process temperatures be provided, applied and maintained during the thermoforming, consolidation or simultaneous consolidation-thermoforming process to ensure consistent and repeatable mechanical and environmental performance. These precise controls will ensure high yields and lower cost.

In all aforementioned processes, there is a definite amount of time that is required to transfer an adequate level of heat or thermal energy from the heat source to the thermoplastic material. This can typically exceed 15 minutes depending on the type of forming die tooling utilized, the type of thermal energy system deployed to create the thermal energy and the size and shape of the thermoplastic and reinforcing layers to be consolidated or thermoformed.

There is typically an equivalent amount of cooling time required to return the now formed or consolidated thermoplastic reinforced composite to a rigid state temperature where it can be handled and further processed. The total cycle time for proper cooling can easily exceed 15 minutes per cycle as well.

There is a definite dependency or relationship developed between the forming die tooling and the thermoplastic carbon composite material. Increases or decreases in temperature are dependent on the forming die tooling to transfer the thermal energy to and from the thermoplastic carbon composite. The physical size of the forming die tooling must be of adequate size to support the pressures of the consolidation or thermoforming process.

The physical size or mass of the consolidation or forming die tooling can be quite large requiring large amounts of watt density per mass energy to elevate the temperatures and complex cooling circuits to remove the same in a controlled manner so as not to induce internal stresses to the forming die tooling or the thermoplastic carbon composite materials.

It is apparent that the overall processing time for consolidation, thermoforming or simultaneous consolidation-thermoforming can easily exceed 30 minutes utilizing the current available equipment and processes.

Typical thermoplastic carbon reinforced composite systems consist of the aforementioned layering scheme, thermoplastic-carbon reinforcement-thermoplastic. The carbon is inherently conductive and this conductivity may be utilized as a carrier for thermal energy created by the introduction of an electrical current through the conductive carbon weave fabric. The introduction of an electrical current through the carbon reinforcement generates resistance heating. Thermal energy in the form of resistance heating creates suitable temperatures to complete thermoforming, consolidation or simultaneous consolidation-thermoforming of thermoplastic carbon composite materials.

The carbon material is inherently electrically resistive and this resistance may also be utilized as a means to monitor temperature changes through the change in the resistance level of the carbon reinforcement.

Typical carbon reinforcement, such as precursor fibers, chopped fiber, continuous fiber and weaved fabric, for example consist of numerous interlaced carbon threads and bundles, all of which are electrically conductive. Each thread consists of numerous fibers which in then wound into a larger thread bundle, which in turn in is weaved into a specific fiber type or weaved fabric. The production tolerances are extremely tight and each sequential process to produce the carbon material is controlled in such a manner to ensure the highest consistency in the structural performance of the carbon weave material regardless of weave type

This high level of precision for mechanical performance can equate to an equally consistent high level of conductivity and resistance levels with the carbon reinforcement.

Elements with an electrical resistance will generate resistance heating or thermal energy upon the application of electrical current. An electrical circuit can be created by introducing an electrical current to the conductive and resistive carbon weave fabric. Carbon weave fabric will create a suitable level of resistance heating to elevate the temperatures of the carbon weave and the layers of thermoplastic material surrounding the carbon allowing it to flow on and into the weave matrix in a very short period of time.

The amount of heat created by the conductive and resistive carbon materials is a function of the level of current applied and the amount of resistance within the carbon reinforcement at a given time. The ability to control the levels of current introduced into the carbon reinforcement during the thermoforming, consolidation and simultaneous consolidation-thermoforming will provide a controlled precise temperature transferred to the thermoplastic materials which is required for the aforementioned processes.

The method to monitor temperature of the carbon reinforcement must not impede on the thermoplastic carbon composite structure. The integration of a temperature monitor such as a thermocouple, for example may provide localized temperature feedback, it may also affect structural performance if said thermocouple impedes the consolidation or thermoforming due to integration of said thermocouple at an improper location. Thermocouples are also location specific monitoring devices. Temperature measurements within a sensitivity range are provided hence other regions may not be at the same temperature level.

Utilization of the inherent resistance of the carbon reinforcement as in integral monitoring device, similar to a Resistance Temperature Detector (RTD) will provide consistent and precise temperature monitoring by detecting changes in the inherent resistance of the carbon reinforcement. Using these changes to alter the applied electrical current source to elevate, maintain or reduce the temperature of the carbon reinforcement and adjacent thermoplastic materials will provide a precise and controlled method for the creation of the required processing temperatures for thermoplastic carbon thermoforming, consolidation and simultaneous consolidation-thermoforming.

The advantages and benefits gained by the use of thermoplastic carbon composites in all applicable industries can be realized upon the development of new processes that reduce processing costs but maintain the desired performance and quality levels.

The cost of thermoplastic carbon composite high strength-to-weight ratio components and assemblies is tolerable to a limit due to the benefits gained by the use of such materials. A method to reduce processing times will equate to lower cost components and assemblies increasing the adoption and use of thermoplastic carbon composite components throughout many industries.

In order for thermoplastic carbon composites to be fully adopted for use in high volume applications, a method to reduce the processing times and associated costs must be developed and be more competitive than other current composite type systems, such as thermoset pre-preg consolidation and forming, hand or machine lay-up and thermoset resin infusion, as examples.

There now becomes a need to create a process that will expedite the creation and transfer of heat or thermal energy to a thermoplastic composite system and an equal need to remove same in order to reduce cycle times for the production of thermoformed, consolidated or simultaneously consolidated and thermoformed thermoplastic composite components and assemblies.

As noted, resistance is an electrical value which defines how strongly a given material opposes the flow of electrical current through the electrically conductive material. The inverse value is conductance, which is the ease to which an electrical current will pass or flow through an electrically conductive material. The resistance levels relatable to the system and method discussed herein may range from ohms to milliohms. Milliohms are associated with Low Level Circuit Resistance.

Low Level Circuit Resistance (LLCR) are values of resistance that are very minute. The range of resistance measured is limited by the equipment utilized to detect these minute values.

Although there are several methods available to measure LLCR, some require additional equipment or manual manipulation to ensure the accuracy of the values measured. To ensure accuracy and to reduce inherent noise, balancing, thermal induced resistance changes, and other measurement errors created by the test support equipment and the materials under test, in one embodiment the system and method discussed herein employs the 4 Wire LLCR Method (Kelvin) to capture resistance levels that are used to influence the amount of current required to affect a temperature change of the integral carbon reinforcement. A Four Wire LLCR system utilizes four (4) separate wires. Two wires provide current or “source”. These source wires pass a current through the device under test (DUT) or item being tested. The remaining two wires are potential leads or “sense” leads, and are used to sense the voltage drop across the DUT. In one embodiment discussed herein, a source and sense connection is made on one side of the carbon, and a source and sense connection is made on the opposing side of the carbon. The voltage drop between the two sense connections is used to determine the resistance levels and more importantly the change in the resistance levels during the increase or decrease in the temperature of the carbon material.

Typical Four Wire Micro-Ohmmeters can resolve resistances as low as 10μΩ as high as 200Ω, with accuracy resolutions of 10μΩ to 10 mΩ respectively. Thus, in one embodiment the sensing current ranges from 100 mA to 1 mA respectively. As noted below, the sensing current refers to the current applied during the sensing phase when resistance is being measured.

In one embodiment, the system and method discussed herein relies on minute shifts in LLCR during the changes in temperature of the carbon materials. The shift is then utilized to trigger an applied increase or decrease in the amount of process current passing through the carbon material. The inherent resistance of the carbon material in turn creates heat within the carbon material during the increase of current, or the inverse affect during the removal of current. Thus, in one embodiment the measured resistance determines the process current applied.

In some embodiments, the system utilizes Direct Current (VDC) for the application of process voltage and current through the carbon material, at a range of, but not limited to, 9 VDC to 24 VDC and 20A to 200A. Applied voltage and current are application specific as physical size, ply count and thermoplastic encapsulation material are considered during the process definition.

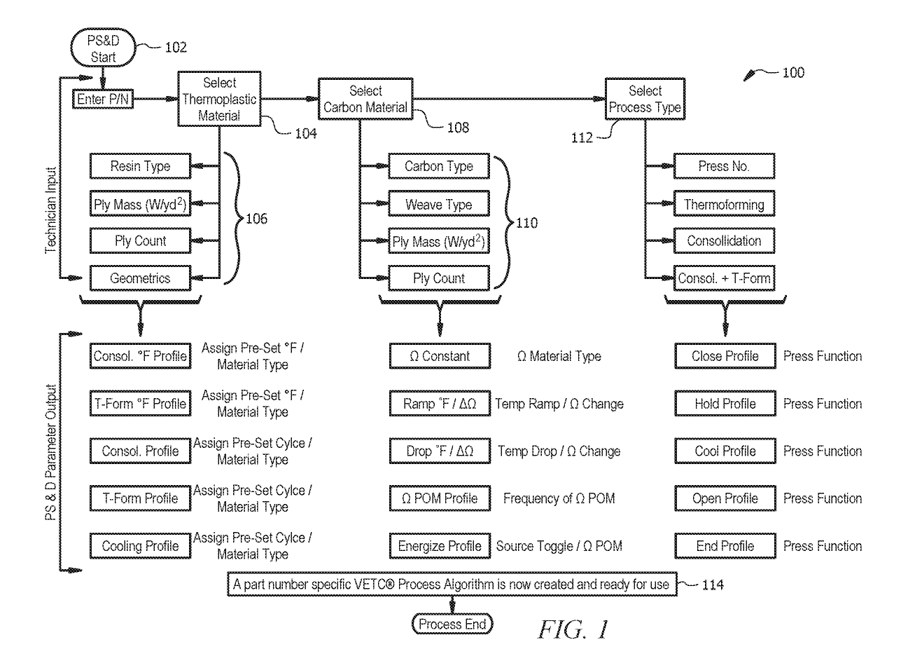

Turning now to FIG. 1, FIG. 1 is a flow diagram illustrating a voltage-enhanced consolidation and thermoforming process 100. The process begins at step 102. At step 104, a thermoplastic material is selected. At step 106, properties of the thermoplastic material are input by a technician. In a typical embodiment, the properties of the thermoplastic material include a resin type, a ply mass, a ply count, and geometry. At step 108, a carbon material is selected. At step 110, properties of the carbon material are input by the technician. In a typical embodiment, the properties of the carbon material include a carbon type, a weave type, a ply mass, and a ply count. At step 112, a process type is selected. In a typical embodiment, the process type is one of thermoforming, consolidation, or simultaneous consolidation and thermoforming. At step 114, a processing algorithm is generated. In a typical embodiment, the processing algorithm includes a temperature profile, an energize profile, a cooling profile, and a relationship between the electrical resistance of the carbon reinforcing layer and the temperature of the carbon reinforcing layer.

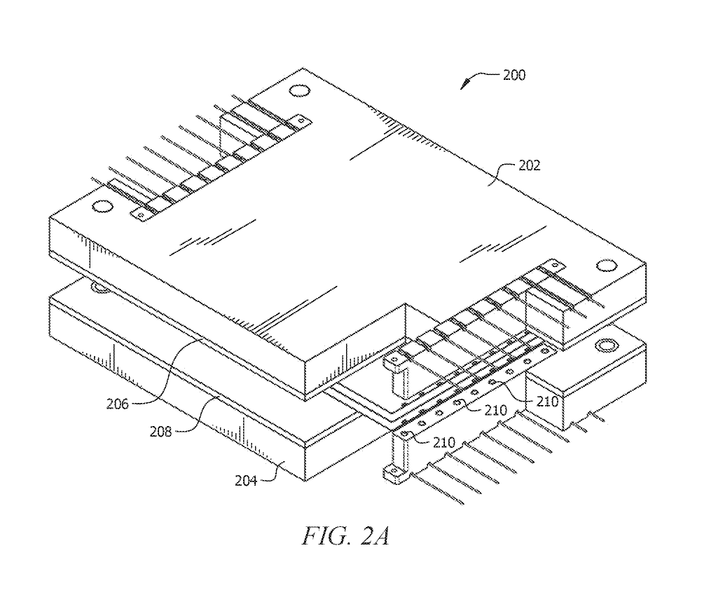

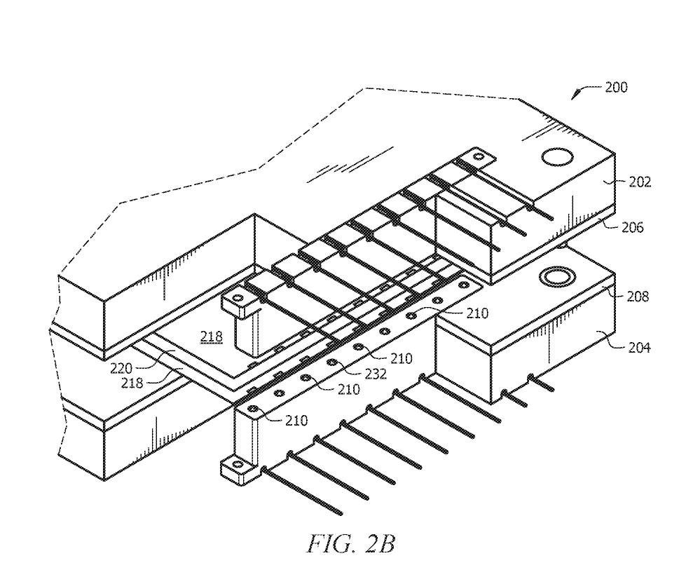

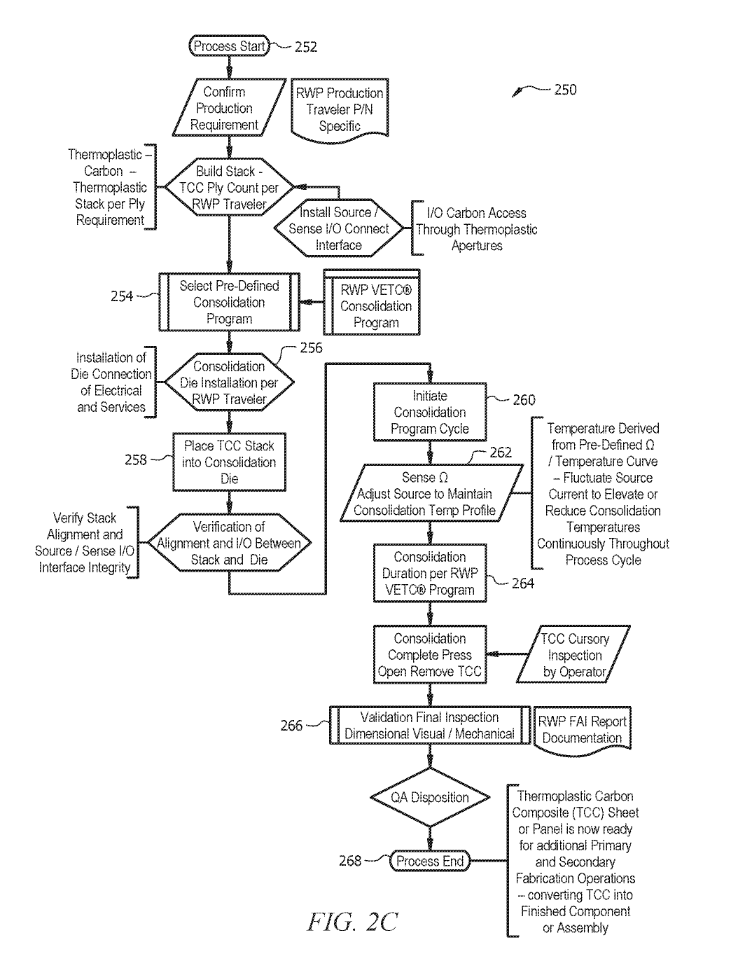

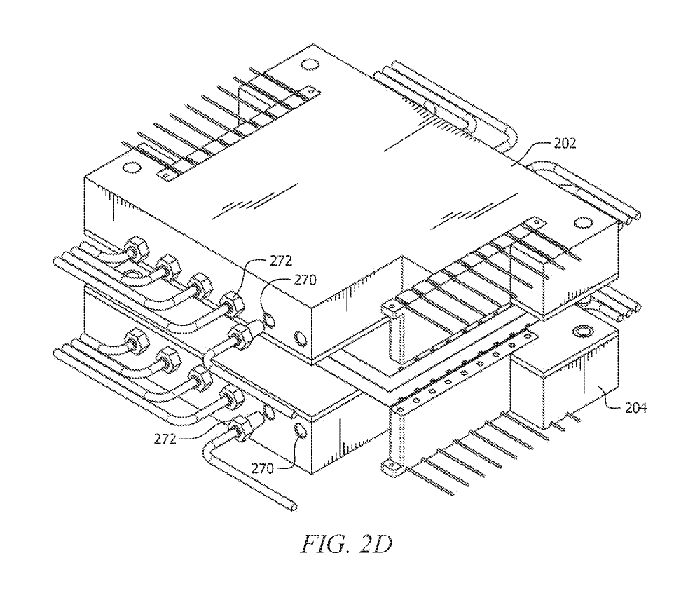

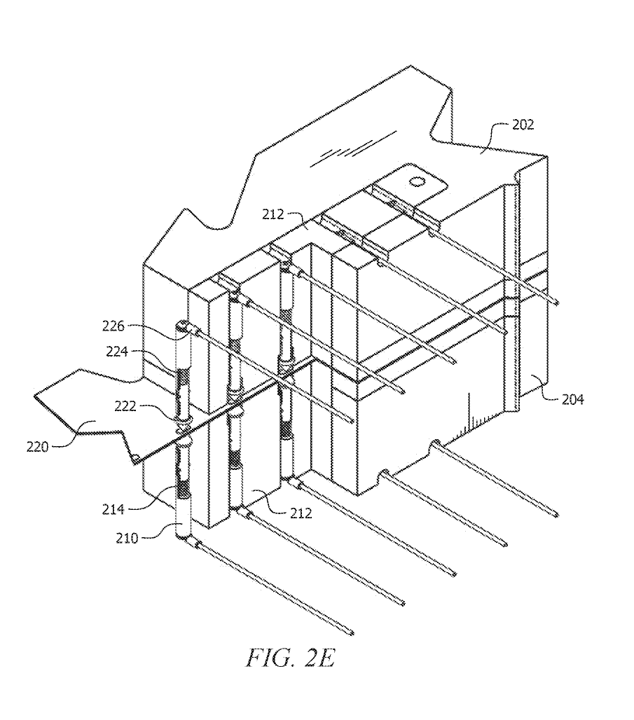

FIG. 2A is a perspective view of voltage-enhanced consolidation system 200. FIG. 2B is a detail view of the voltage-enhanced consolidation system 200. Referring to FIGS. 2A-2B, the voltage-enhanced consolidation system includes an upper form die 202 and a lower form die 204. In a typical embodiment, the upper form die 202 and the lower form die 204 include a geometry that is specific to a particular application; however, in a typical embodiment, the voltage-enhanced consolidation system 200 includes an upper form die 202 and a lower form die 204 that comprise a flat internal surface. In a typical embodiment, the upper form die 202 and the lower form die 204 are vertically aligned within, for example, a clamping press system. The clamping press system is typically capable of imparting a suitable high pressure clamping force to the upper form die 202 and the lower form die 204. In a typical embodiment, a defined space is present between the upper form die 202 and the lower form die 204. A width of the defined space corresponds to a desired thickness of the consolidated material. The high pressure clamping force is suitable to precipitate the manipulation and subsequent encapsulation of the thermoplastic material on and about the carbon reinforcement material. The upper form die 202 and the lower form die 204 are aligned in a manner that a front surface of the upper form die 202 is facing a front surface of the lower form die 204. The upper form die 202 and the lower form die 204 are mateable when moved into contact with each other. In various embodiments, integral alignment pins and bushings may be utilized to provide repeatable alignment of the upper form die 202 and the lower form die 204.

Still referring to FIGS. 2A-2B, a first thermal insulator 206 is coupled to the upper form die 202 and a second thermal insulator 208 is coupled to the lower form die 204. In various embodiments, as shown in FIG. 2D, a plurality of cooling channels 270 may be disposed in at least one of the upper form die 202 and the lower form die 204. In a typical embodiment, the cooling channels 270 include a mechanical connection 272 located at sides or ends of the of the upper form die 202 or the lower form die 204 to allow connection to liquid media cooling or forced air cooling systems. In a typical embodiment, the cooling channels 270 support reduction of temperature developed within the thermoplastic and carbon material layers and the tool portions upon completion of the consolidation process.

FIG. 2E is a detail cut-away view of the voltage-enhanced consolidation system 200 illustrating a plurality of electrical contact devices 200. The upper form die 202 and the lower form die 204 include a plurality of electrical contact devices 210. The plurality of electrical contact devices 210 include an electrically insulated housing 212 and an electrically conductive member 214 disposed therein. In a typical embodiment, the electrically conductive member 214 is biased into contact with a carbon ply layer 220. In a typical embodiment, the electrically conductive member 214 penetrates an aperture formed in a thermoplastic layer 218 to contact the carbon ply layer 220. The electrically conductive member 214 includes a front probe tip 222, a spring loaded conductive member 224, and an interconnection portion 226. In a typical embodiment, the front probe tip 222 penetrates apertures formed in a thermoplastic layer 218 so as to contact a carbon reinforcing layer 220. In a typical embodiment, the spring loaded conductive member 224 provides electrical contact between the front probe tip 222 and the interconnection portion 226 regardless of the degree of compression of the spring loaded conductive member 224. The spring loaded conductive member 224 provides contact force between the front probe tip 222 and the carbon reinforcing layer 220. In a typical embodiment, the interconnection portion 226 includes a mechanical fastener to affect an electrical connection to a source of electrical current or to an electrical monitoring system. In various embodiments, the electrical connection may include, for example, an electrically conductive wire or flexible circuitry. Contact of the plurality of electrical contact devices 210 to the carbon reinforcing layer 220 creates an electrically conductive circuit between the current source and the carbon reinforcing layer 220.

Still referring to FIG. 2A-2B, the quantity of electrical contact devices 210 may vary as dictated by application and design requirements. In various embodiments, certain ones of the plurality of electrical contact devices 210 may be utilized for application of electrical current while others of the plurality of electrical contact devices may be utilized for monitoring electrical properties of the carbon reinforced thermoplastic composite.

Electrical connections are provided to connect the aforementioned device members and electrical conductive circuit to a Process Controller. Said process controller provides a suitable supply of electrical current. Said process controller further comprises an electrical monitoring interface. Said process controller further contains pre-defined process algorithm library from which a baseline consolidation algorithm is selected. Said algorithm defines the baseline process parameters for specific material types and processes, such as temperature, pressures, duration and clamping press movements, for example.

Upon initiation, the tool portions within the clamping press will move and become substantially mated at low pressure. The process controller will capture baseline resistance levels of the integral carbon reinforcement and forming die tool portion temperatures. Operator input will initiate a process cycle whereby monitoring will capture said resistance, upon resistance capturing, monitoring capability will be disabled, electrical current application will be enabled and a specific level of electrical current will be applied to and through the said device members and into said carbon reinforcement. Upon the application of the specified electrical current, a temperature rise will occur within the carbon reinforcement.

During said heat rise process, electrical current application will be disabled and monitoring capability will be enabled. Monitoring will capture additional resistance levels and once again be disabled. Said electrical current level will be altered to affect an additional rise or drop in temperature. Once current settings are modified, said electrical current will be enabled and current will once again be applied to the carbon material. The cycle of monitoring and application of electrical current will toggle enable-disable-enable numerous times during heat rise until there is suitable temperature within the carbon reinforcement, transferred to the thermoplastic material, to affect an adequate encapsulation or consolidation of the thermoplastic material on and about the carbon reinforcement.

Upon reaching the required temperature for the application, the substantially mated tool portions will be subjected to an increase in clamping pressures precipitating encapsulation of the thermoplastic material on and about the carbon reinforcement. Upon reaching the desired level and thickness of consolidation, the applied electrical current will be disabled.

The aforementioned liquid media cooling or forced air cooling is now enabled to reduce processing temperatures to a level allowing handling. Monitoring will become enabled and resistance temperature monitoring will be provided until such time when temperatures are reduced for the removal of the thermoplastic carbon composite.

Upon reaching said reduced temperature level, the clamping press removes all clamping pressure forces and the tool portions are separated to allow the removal of the completed consolidated thermoplastic carbon composite.

FIG. 2C is a flow diagram illustrating a voltage-enhanced consolidation process 250. The process 250 starts at step 252. At step 254, a predefined consolidation program is selected. At step 256, a consolidation die is selected and installed. At step 258, a stack of at least one thermoplastic layer and at least one carbon reinforcing layer are placed into the consolidation die. At step 260, the consolidation cycle is initiated. At step 262, electrical resistance of the carbon reinforcing layer is sensed and the applied voltage is adjusted to maintain a proper consolidation temperature profile. At step 264, the at least one thermoplastic layer and the at least one carbon reinforcing layer are consolidated. At step 266, the consolidated carbon reinforced thermoplastic is inspected. The process 250 ends at step 268.

In another aspect, the present invention relates to the thermoforming of a pre-consolidated thermoplastic carbon reinforced composite sheet or panel into a pre-defined 3 dimensional (3D) geometry. Said panel is comprised of a single layer or single ply of a thermoplastic material layer—reinforcing carbon weave layer—thermoplastic material layering scheme. Multilayer or multiply systems consist of said layering scheme repeated by the number of layers or ply's required for a specific application. In any case, the amount of thermoplastic resin for each layer is symmetric about the carbon reinforcement with thermoplastic residing on opposing sides of the carbon layer. Said layers are consolidated into a sheet or panel of desired thickness and dimension. Said sheet or panel is substantially planar. Said sheet or panel further consists of an upper surface, a lower surface substantially parallel to the upper surface, and side surfaces that are substantially perpendicular to the upper and lower surfaces.

The thermoplastic carbon composite sheet or panel further comprises apertures through the thermoplastic material, exposing the carbon reinforcement. Said apertures are provided, but not by limitation, through the upper and lower surfaces of the thermoplastic and about the perimeter of said sheet or panel.

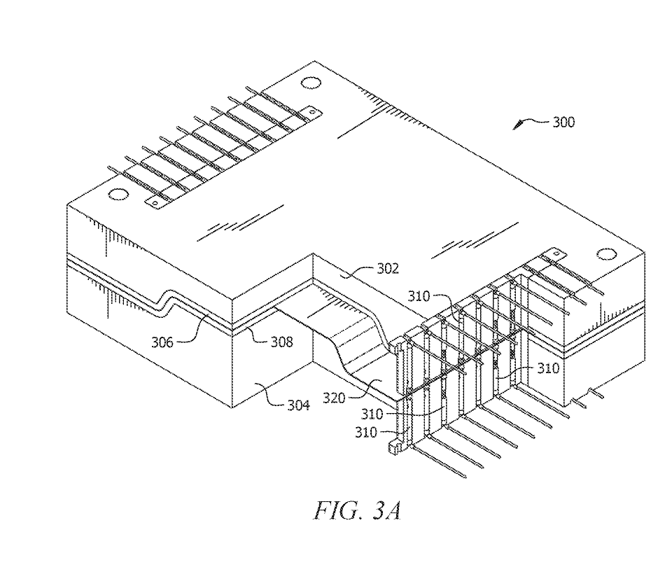

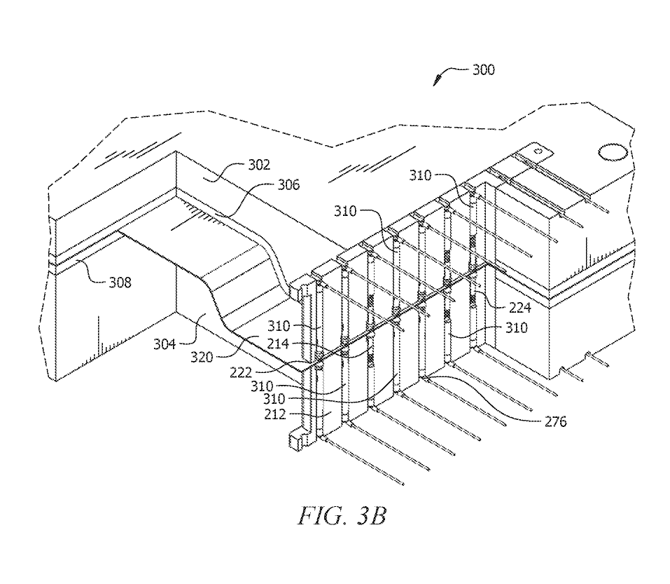

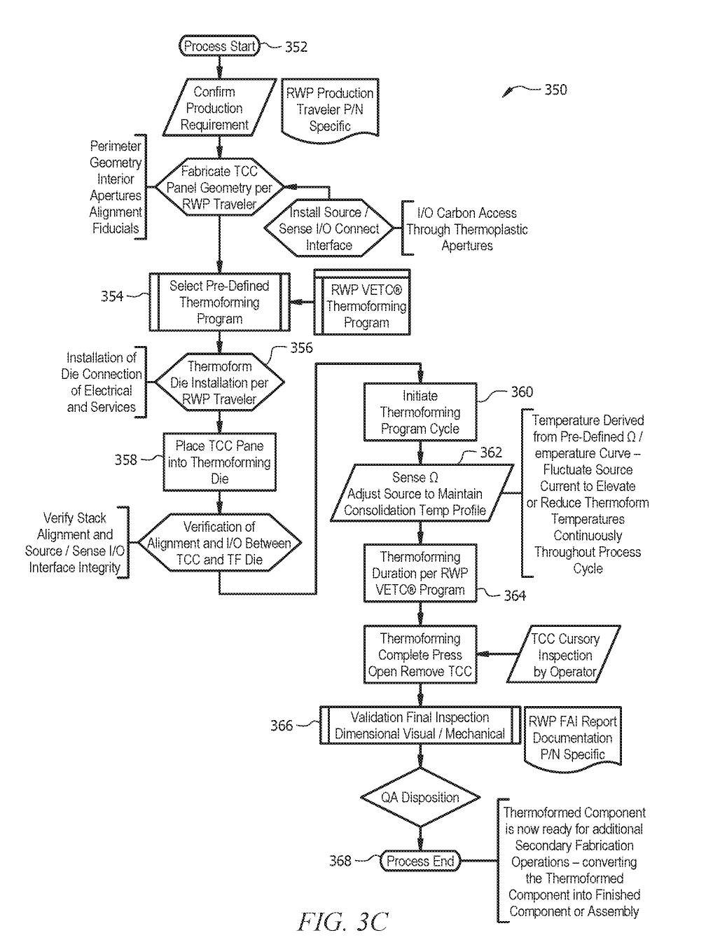

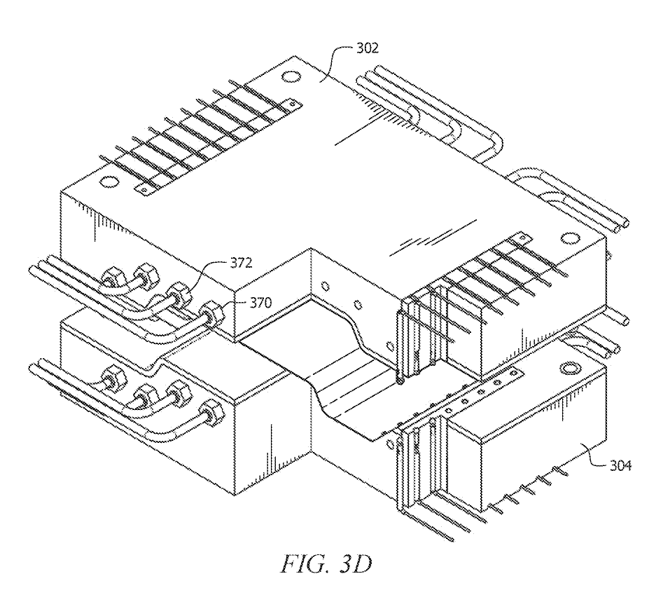

FIG. 3A is a perspective view of voltage-enhanced thermoforming system 300. FIG. 3B is a detail view of the voltage-enhanced thermoforming system 300. Referring to FIGS. 3A-3B, the voltage-enhanced thermoforming system includes an upper form die 302 and a lower form die 304. In a typical embodiment, the upper form die 302 and the lower form die 304 include a geometry that is specific to a particular application. In a typical embodiment, press and clamping forces first applied to flat peripheral surfaces of the upper form die 302 and the lower form die 304 and then transferred to through the upper form die 302 and the lower form die 304 to internal surfaces that are shaped to a prescribed geometry. In a typical embodiment, the upper form die 302 and the lower form die 304 are vertically aligned within, for example, a clamping press system. The clamping press system is typically capable of imparting a suitable high pressure clamping force to the upper form die 302 and the lower form die 304. In a typical embodiment, a defined space is present between the upper form die 302 and the lower form die 304. A width of the defined space corresponds to a desired thickness of the thermoformed material. The high pressure clamping force is suitable to precipitate the manipulation and subsequent forming of the consolidated carbon reinforced thermoplastic material. The upper form die 302 and the lower form die 304 are aligned in a manner that a front surface of the upper form die 302 is facing a front surface of the lower form die 304. The upper form die 302 and the lower form die 304 are mate-able when moved into contact with each other. In various embodiments, integral alignment pins and bushings may be utilized to provide repeatable alignment of the upper form die 302 and the lower form die 304.

Still referring to FIG. 3A-3B, a first thermal insulator 306 is coupled to the upper form die 302 and a second thermal insulator 308 is coupled to the lower form die 304. In various embodiments, as shown in FIG. 3D, a plurality of cooling channels 370 may be disposed in at least one of the upper form die 302 and the lower form die 304. In a typical embodiment, the cooling channels 370 include a mechanical connection 372 located at sides or ends of the of the upper form die 302 or the lower form die 304 to allow connection to liquid media cooling or forced air cooling systems. In a typical embodiment, the cooling channels 370 support reduction of temperature developed within the thermoplastic and carbon material layers and the tool portions upon completion of the thermoforming process.

Still referring to FIG. 3A-3B, the upper form die 302 and the lower form die 304 include a plurality of electrical contact devices 310. The plurality of electrical contact devices 310 include an electrically insulated housing 312 and an electrically conductive member 314 disposed therein. In a typical embodiment, the electrically conductive member 314 is biased into contact with a consolidated carbon reinforced thermoplastic material 320. The electrically conductive member 314 includes a front probe tip 322, a spring loaded conductive member 324, and an interconnection portion 326. In a typical embodiment, the front probe tip 322 penetrates apertures formed in a thermoplastic layer so as to contact a carbon reinforcing layer 320. In a typical embodiment, the spring loaded conductive member 324 provides electrical contact between the front probe tip 322 and the interconnection portion 326 regardless of the degree of compression of the spring loaded conductive member 324. The spring loaded conductive member 324 provides contact force between the front probe tip 322 and the carbon reinforcing layer 320. In a typical embodiment, the interconnection portion 326 includes a mechanical fastener to affect an electrical connection to a source of electrical current or to an electrical monitoring system. In various embodiments, the electrical connection may include, for example, an electrically conductive wire or flexible circuitry. Contact of the plurality of electrical contact devices 310 to the carbon reinforcing layer 320 creates an electrically conductive circuit between the current source and the carbon reinforcing layer 320.

Still referring to FIG. 3A-3B, the quantity of electrical contact devices 310 may vary as dictated by application and design requirements. In various embodiments, certain ones of the plurality of electrical contact devices 310 may be utilized for application of electrical current while others of the plurality of electrical contact devices may be utilized for monitoring electrical properties of the carbon reinforced thermoplastic composite.

Electrical connections are provided to connect the aforementioned device members and electrical conductive circuit to a Process Controller. Said process controller provides a suitable supply of electrical current. Said process controller further comprises an electrical monitoring interface. Said process controller further contains pre-defined process algorithm library from which a baseline thermoforming algorithm is selected. Said algorithm defines the baseline process parameters for specific material types and processes, such as temperature, pressures, duration and clamping press movements, for example.

Upon initiation, the tool portions within the clamping press will move and become substantially mated at low pressure. The process controller will capture baseline resistance levels of the integral carbon reinforcement and forming die tool portion temperatures. Operator input will initiate a process cycle whereby monitoring will capture said resistance, upon resistance capturing, monitoring capability will be disabled, electrical current application will be enabled and a specific level of electrical current will be applied to and through the said device members and into said carbon reinforcement. Upon the application of the specified electrical current, a temperature rise will occur within the carbon reinforcement.

During said heat rise process, electrical current application will be disabled and monitoring capability will be enabled. Monitoring will capture additional resistance levels and once again be disabled. Said electrical current level will be altered to affect an additional rise or drop in temperature. Once current settings are modified, said electrical current will be enabled and current will once again be applied to the carbon material. The cycle of monitoring and application of electrical current will toggle enable-disable-enable numerous times during heat rise until there is suitable temperature within the carbon reinforcement, transferred to the thermoplastic material, to affect an adequate forming of the thermoplastic carbon composite sheet or panel.

Upon reaching the required temperature for the application, the substantially mated tool portions will be subjected to an increase in clamping pressures precipitating thermoforming of the thermoplastic carbon composite. Upon reaching the desired level forming, the applied electrical current will be disabled.

The aforementioned liquid media cooling or forced air cooling is now enabled to reduce processing temperatures to a level allowing handling. Monitoring will become enabled and resistance temperature monitoring will be provided until such time when temperatures are reduced for the removal of the formed thermoplastic carbon composite. Upon reaching said reduced temperature level, the clamping press removes all clamping pressure forces and the tool portions are separated to allow the removal of the completed formed thermoplastic carbon composite.

FIG. 3C is a flow diagram illustrating a voltage-enhanced thermoforming process 350. The process 350 starts at step 352. At step 354, a predefined thermoforming program is selected. At step 356, a thermoforming die is selected and installed. At step 358, a pre-consolidated stack of at least one thermoplastic layer and at least one carbon reinforcing layer are placed into the thermoforming die. At step 360, the thermoforming cycle is initiated. At step 362, electrical resistance of the carbon reinforcing layer is sensed and the applied voltage is adjusted to maintain a proper thermoforming temperature profile. At step 364, the at least one thermoplastic layer and the at least one carbon reinforcing layer are thermoformed. At step 366, the thermoformed carbon reinforced thermoplastic is inspected. The process 350 ends at step 368.

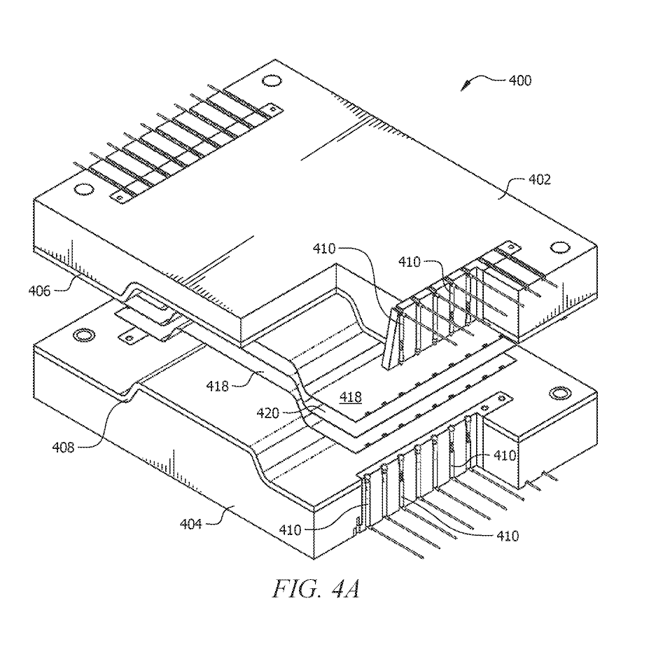

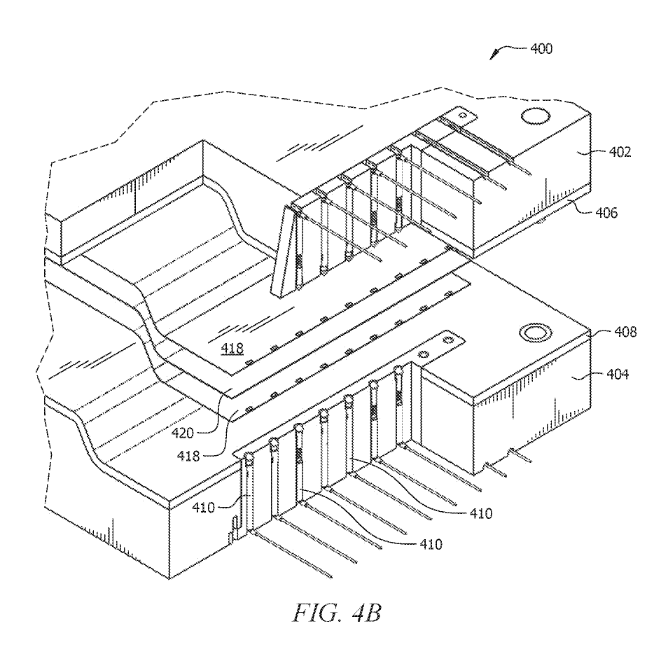

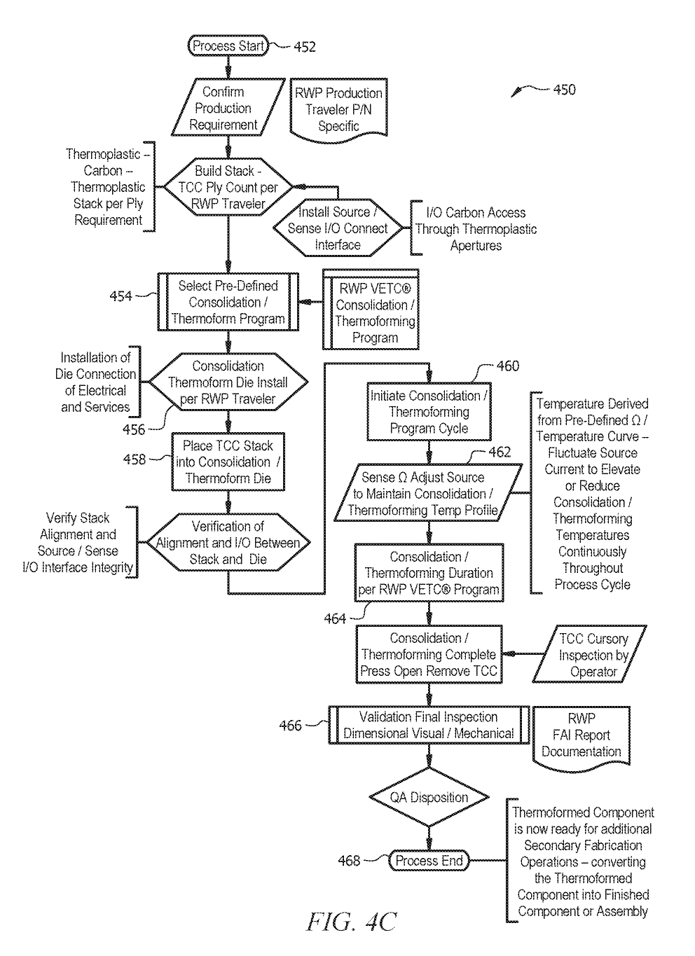

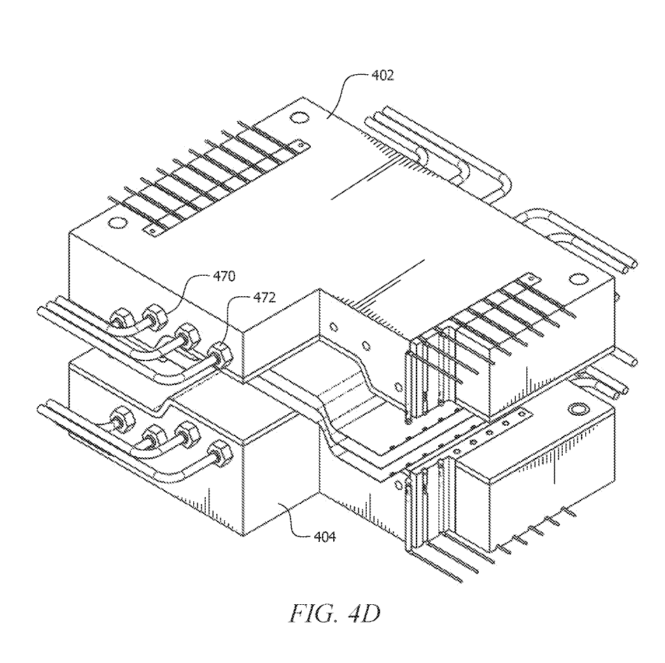

FIG. 4A is a perspective view of voltage-enhanced consolidation and thermoforming system 400. FIG. 4B is a detail view of the voltage-enhanced consolidation and thermoforming system 400. Referring to FIGS. 4A-4B, the voltage-enhanced consolidation and thermoforming system includes an upper form die 402 and a lower form die 404. In a typical embodiment, the upper form die 402 and the lower form die 404 include a geometry that is specific to a particular application. In a typical embodiment, the upper form die 402 and the lower form die 404 are vertically aligned within, for example, a clamping press system. The clamping press system is typically capable of imparting a suitable high pressure clamping force to the upper form die 402 and the lower form die 404. In a typical embodiment, a defined space is present between the upper form die 402 and the lower form die 404. A width of the defined space corresponds to a desired thickness of the consolidated material. The high pressure clamping force is suitable to precipitate the manipulation and subsequent encapsulation of the thermoplastic material on and about the carbon reinforcement material as well as the subsequent forming of the resulting thermoplastic carbon reinforced material. The upper form die 402 and the lower form die 404 are aligned in a manner that a front surface of the upper form die 402 is facing a front surface of the lower form die 404. The upper form die 402 and the lower form die 404 are mateable when moved into contact with each other. In various embodiments, integral alignment pins and bushings may be utilized to provide repeatable alignment of the upper form die 402 and the lower form die 404.

Still referring to FIG. 4A-4B, a first thermal insulator 406 is coupled to the upper form die 402 and a second thermal insulator 408 is coupled to the lower form die 404. In various embodiments, a plurality of cooling channels may be disposed in at least one of the upper form die 402 and the lower form die 404. In a typical embodiment, the cooling channels include a mechanical connection located at sides or ends of the of the upper form die or the lower form die to allow connection to liquid media cooling or forced air cooling systems. In a typical embodiment, the cooling channels support reduction of temperature developed within the thermoplastic and carbon material layers and the tool portions upon completion of the consolidation and thermoforming process.

Still referring to FIG. 4A-4B, the upper form die 402 and the lower form die 404 include a plurality of electrical contact devices 410. The plurality of electrical contact devices 410 include an electrically insulated housing 412 and an electrically conductive member 414 disposed therein. In a typical embodiment, the electrically conductive member 414 is biased into contact with a carbon ply layer 420. In a typical embodiment, the electrically conductive member 414 penetrates an aperture formed in a thermoplastic layer 418 to contact the carbon ply layer 420. The electrically conductive member 414 includes a front probe tip 422, a spring loaded conductive member 424, and an interconnection portion 426. In a typical embodiment, the front probe tip 422 penetrates apertures formed in a thermoplastic layer 418 so as to contact a carbon reinforcing layer 420. In a typical embodiment, the spring loaded conductive member 424 provides electrical contact between the front probe tip 422 and the interconnection portion 426 regardless of the degree of compression of the spring loaded conductive member 424. The spring loaded conductive member 424 provides contact force between the front probe tip 422 and the carbon reinforcing layer 420. In a typical embodiment, the interconnection portion 426 includes a mechanical fastener to affect an electrical connection to a source of electrical current or to an electrical monitoring system. In various embodiments, the electrical connection may include, for example, an electrically conductive wire or flexible circuitry. Contact of the plurality of electrical contact devices 410 to the carbon reinforcing layer 420 creates an electrically conductive circuit between the current source and the carbon reinforcing layer 420.

Still referring to FIG. 4A-4B, the quantity of electrical contact devices 410 may vary as dictated by application and design requirements. In various embodiments, certain ones of the plurality of electrical contact devices 410 may be utilized for application of electrical current while others of the plurality of electrical contact devices may be utilized for monitoring electrical properties of the carbon reinforced thermoplastic composite.

FIG. 4C is a flow diagram illustrating a voltage-enhanced consolidation thermoforming process 450. The process 450 starts at step 452. At step 454, a predefined thermoforming program is selected. At step 456, a consolidation thermoforming die is selected and installed. At step 458, a stack of at least one thermoplastic layer and at least one carbon reinforcing layer are placed into the consolidation thermoforming die. At step 460, the consolidation thermoforming cycle is initiated. At step 462, electrical resistance of the carbon reinforcing layer is sensed and the applied voltage is adjusted to maintain a proper thermoforming temperature profile. At step 464, the at least one thermoplastic layer and the at least one carbon reinforcing layer are simultaneously consolidated and thermoformed. At step 466, the consolidated and thermoformed carbon reinforced thermoplastic is inspected. The process 450 ends at step 468.

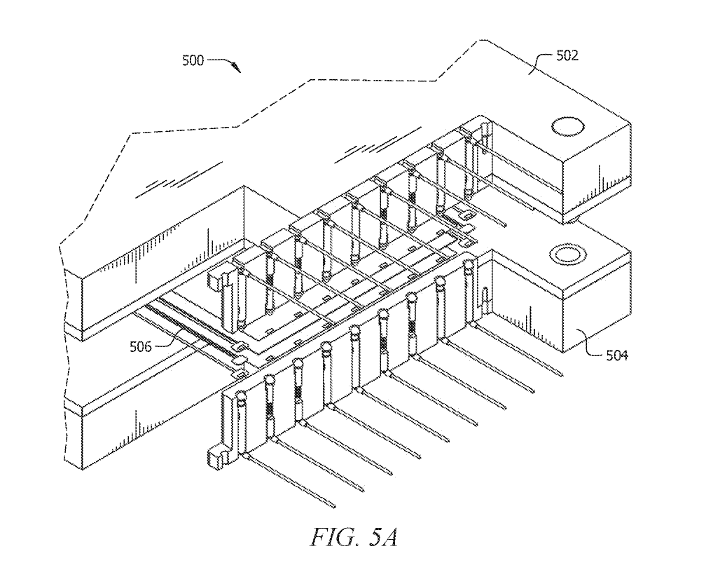

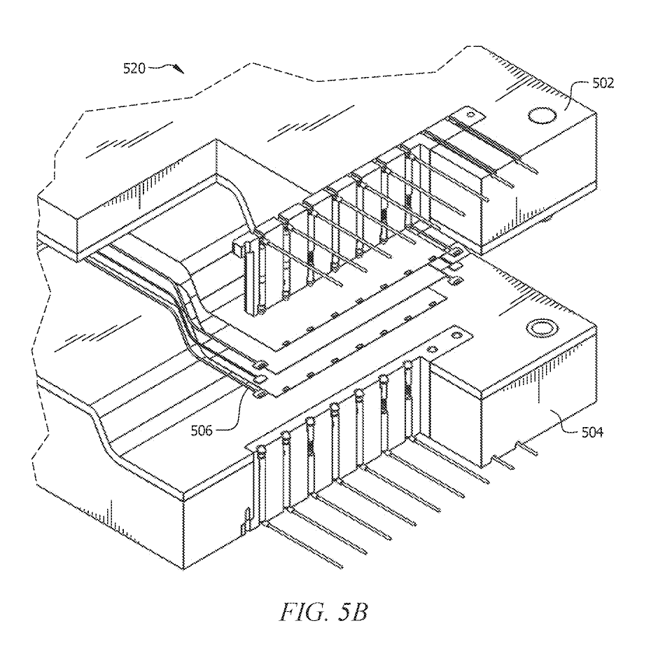

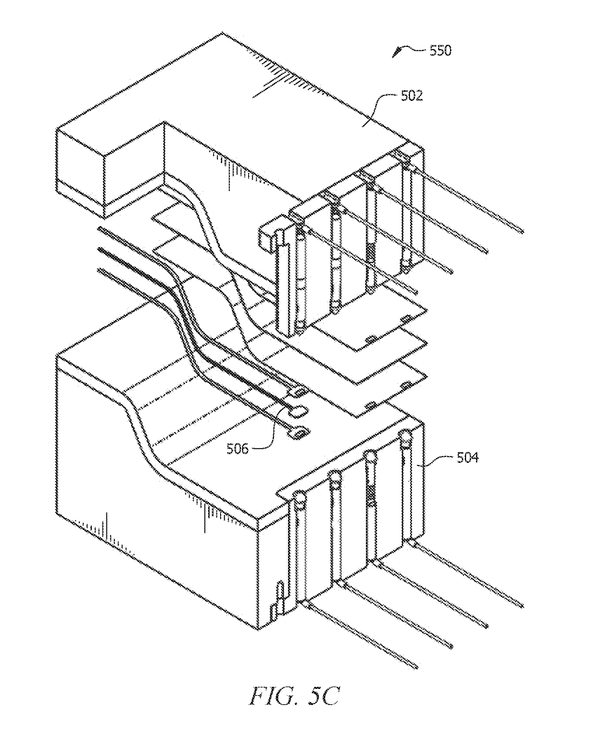

FIG. 5A is an exploded cut away enlarged view of a voltage enhanced consolidation system 500 with redundant resistance temperature detection (RTD). FIG. 5B is an exploded cut away enlarged view of a thermoforming system 520 with redundant resistance temperature detection (RTD) FIG. 5C is an exploded cut away enlarged view of a simultaneous consolidation and thermoforming system 550 with redundant resistance temperature detection (RTD). The RTD system can be utilized when the measured resistance change of the carbon reinforcing layer becomes too minute to utilize to determine the proper process current. Thus, when the shift in resistance is insufficient to be used as a control, the RTD system can be utilized. In this system, leads are laid adjacent to the carbon plies. These materials, known in the art, are sensitive to temperature changes. In certain circumstances, they can be used to determine the applied process current as the temperature can be obtained from the RTD with the use of a supplementary temperature transmitter display

In one embodiment the RTD is not in the load path, and therefore, will not interfere with the mechanical performance of the carbon reinforced thermoplastic element. Additionally, RTD systems are more sensitive than thermocouples. They are thin and accordingly very fast to react. The RTD system can be used alone or in combination with the algorithm discussed herein which utilizes the measured resistance to determine process current. In some embodiments the RTD is the primary decision-maker, whereas in other embodiments the RTD is used to supplement or enhance the parallel algorithm which measures resistance by applying a sensing current and adjusts process current.

Referring to FIGS. 5A-5C collectively, the voltage-enhanced consolidation system 500 includes an upper form die 502 and a lower form die 504. In a typical embodiment, the upper form die 502 and the lower form die 504 are similar in construction to the upper form die 202 and the lower form die 204 discussed above with respect to FIGS. 2A-2C. A redundant resistant temperature device (RTD) 506 is positioned between the upper form die 502 and the lower form die 504 adjacent to the thermoplastic and carbon reinforced materials. In a typical embodiment, the RTD 506 is not integrated with the thermoplastic material or with the carbon reinforced material as such integration can adversely impact load paths and structural integrity of the resulting carbon reinforced thermoplastic material. In various applications the size or the resistance level of the carbon reinforcement do not support integral sensing of resistance. As such, in these applications, there may not be a suitable measurable shift in the electrical resistance of the carbon reinforcing material to trigger a modulation of the applied current. To address this issue, the RTD 506 is more sensitive to temperature change than carbon and thus provides a measurable change in resistance so as to trigger modulation of the electrical current applied to the thermoplastic material and to the carbon reinforcing material.

While various systems have been described, a method utilizing the systems will now be described. In one embodiment at least one thermoplastic layer and one carbon reinforcing layer are inserted into a die. The die, as previously described, comprises an upper form die, a first thermal insulator coupled to said upper form die and a lower form die with a second thermal insulator coupled to said lower form die. The dies, as noted above, can comprise various shapes, either planar or geometric, and can have various sizes and thicknesses. The first and second thermal insulator can comprise the same or different material. In one embodiment the thermal insulator further comprises a release agent to prevent the thermoplastic layer and or carbon reinforcing layers from adhering to the thermal insulator. As noted, in one embodiment the upper form die and lower form die each comprises a plurality of electrical contact devices which are electrically coupled to an electrical current source and an electrical monitoring system.

The operator will enter or select the type of material to be formed into a program. As an example, the operator can select the type of thermoplastic layer and type of carbon reinforcing layer. The operator can also select thickness, ply type, etc. A computer program will utilize a database which comprises information and data related to the various materials. In one embodiment, the database comprises information related to the relationship between resistance and temperature. The program utilizes this information to set an initial process current and/or voltage and an initial sensing current and/or voltage. In one embodiment the initial process current and/or voltage and the initial sensing current and/or voltage will change depending upon the material, thickness, etc. which was entered into the program.

After an initial sensing current is obtained, the electrical resistance through the carbon reinforcing layer is determined by applying the sensing current. The temperature of the carbon reinforcing layer can be determined based on the measured electrical resistance. In one embodiment the measurement and calculation occurs in real-time. This was not possible with traditional temperature sensors such as a thermocouple which required a significant time delay.

After measuring the electrical resistance, the first process current and/or voltage is applied. As noted, a process current is the current which is used to heat the carbon reinforcing and thermoplastic layers. Thus, the heating source is the process current and/or voltage.

Thereafter, the temperature of the carbon can be obtained by again sensing the resistance. The resulting process current and/or voltage is adjusted depending upon the determined temperature. In this fashion, the resistance is used as a parameter to adjust the process current.

As noted, in one embodiment the process current and sensing current are not applied simultaneously. Instead, a sensing current is applied, and the resistance is measured. Then, and not simultaneously, a process current is applied. The system can toggle back and forth between the sensing current and process current as needed. Thus, the system will apply a sensing current, sense the resistance, and then apply a process current.

The system and method discussed herein offers a plurality of benefits. A first benefit is increased throughput. As noted in one embodiment, creating the consolidation and or thermoforming temperatures within the carbon reinforcing layers eliminates the excessive time required to elevate the temperature of the large conventional forming dies by common methods. By the use of thermal barriers or insulators between the forming dies and the thermoplastic and carbon reinforcing layers at elevated temperatures, the large forming dies are operated at near ambient temperatures. Cooling requirements are now confined to the thermoplastic and carbon reinforcing layers and the thermal barrier or insulators of the forming dies. This drastically reduces the cooling cycle time as compared to cooling the large forming dies by conventional methods. Reducing the cycle times for temperature elevation and temperature reduction reduces cost and maximizes profit.

A second benefit is the ability to form and shape at the same time. Previously a consolidation step was utilized to create the reinforced layers. The layers were stored, and then subsequently reheated and formed to the desired shape. In one embodiment, the system and method discussed herein provides for the ability to consolidate and thermoform simultaneously. This reduces storage cost, transporting costs, and reduces a separate processing step. Consequently, this reduces cost and maximizes profit

Finally, as noted, in one embodiment the system does not utilize thermocouples. There are two reasons for this. First, a thermocouple, if placed in the load path, will affect the mechanical performance of the carbon reinforced thermoplastic element. Thus, the thermocouple would interrupt the load path. This is true both for the sensing stage as well as the process stage. Second, using resistance as an input offers a more precise, and faster, roadmap for controlling temperature.

Although various embodiments of the method and system of the present invention have been illustrated in the accompanying Drawings and described in the foregoing Specification, it will be understood that the invention is not limited to the embodiments disclosed, but is capable of numerous rearrangements, modifications, and substitutions without departing from the spirit and scope of the invention as set forth herein. It is intended that the Specification and examples be considered as illustrative only.

What is claimed is:

1. A die system comprising:
an upper form die;
a first thermal insulator coupled to said upper form die;
a lower form die;
a second thermal insulator coupled to said lower form die;
wherein said upper form die and said lower form die each comprises a plurality of electrical contact devices;
wherein each of said plurality of electrical devices are electrically coupled to an electrical current source and an electrical monitoring system.

2. The die system of claim 1 wherein said upper form die and said lower form dies do not comprise a thermocouple.

3. The die system of claim 3 further comprising at least one thermoplastic layer and at least one carbon reinforcing layer.

4. The die system of claim 3 wherein electrical contact devices each comprise an electrically insulated housing and an electrically conductive member disposed in said insulated housing.

5. The die system of claim 4 wherein said electrical contact device further comprises a front probe tip which makes electric contact with said carbon reinforcing layer, wherein contact with said carbon reinforcing layer creates an electrically conductive circuit between said electrical current source and the carbon reinforcing layer.

6. The die system of claim 5 wherein said front probe tip penetrates an aperture formed in said thermoplastic layer.

7. The die system of claim 5 wherein said electrically conductive member is biased into contact with said carbon reinforced layer.

8. The die system of claim 1 wherein said electrical monitoring system monitors resistance through said carbon layer.

9. The die system of claim 8 further comprising a process controller which disables resistance monitoring when a process current is applied, and which enables resistance monitoring when a sensing current is applied.

10. The die system of claim 1 wherein said upper die form comprises a plurality of cooling channels.

11. The die system of claim 1 wherein said upper form die and lower form die comprise a flat internal surface.

12. The die system of claim 1 wherein said upper form and said lower form dies result in a 3D geometry.

13. The die system of claim 1 wherein said upper form and said lower form dies result in a planar geometry.

14. A method comprising:
a) inserting at least one thermoplastic layer and one carbon reinforcing layer into a die, wherein said die comprises an upper form die, a first thermal insulator coupled to said upper form die, a lower form die, a second thermal insulator coupled to said lower form die, wherein said upper form die and said lower form die each comprises a plurality of electrical contact devices; wherein each of said plurality of electrical devices are electrically coupled to an electrical current source and an electrical monitoring system;
b) sensing the electrical resistance through said carbon reinforcing layer with a sensing current;
c) applying a first process current to said carbon reinforcing layer;
d) sensing the electrical resistance through said carbon reinforcing layer with a sensing current;
e) applying a second process current to said carbon reinforcing layer.

15. The method of claim 13 wherein said first process current is determined based on said sensed electrical resistance of step b).

16. The method of claim 13 further comprising achieving application process temperature.

17. The method of claim 15 further comprising applying a pressure to said die.

18. The method of claim 1 comprising consolidation.

19. The method of claim 1 comprising thermoforming.

20. The method of claim 1 comprising simultaneous consolidation and thermoforming.
